(19) United States
(12) Patent Application Publication
(10) Pub. No.: US 2022/0203578 A1
(43) Pub. Date: Jun. 30, 2022

(54) DIAPHRAGM FORMING MOLD

(71) Applicant: AAC Microtech (Changzhou) Co., Ltd., Changzhou City (CN)

(72) Inventors: Feiyang Yuan, Shenzhen (CN); Haifei Huang, Shenzhen (CN); Zhiwei Zhong, Shenzhen (CN); Tong Zhang, Shenzhen (CN); Ping Liang, Shenzhen (CN)

(21) Appl. No.: 17/547,252

(22) Filed: Dec. 10, 2021

(30) Foreign Application Priority Data
Dec. 25, 2020 (CN) 202023200475.5

(51) Int. Cl. B29C 33/44; H04R 31/00

(52) U.S. Cl. CPC B29C 33/44; B29L 2031/755; H04R 31/003

(57) ABSTRACT

The present disclosure provides a diaphragm forming mold, including includes a mold body, the mold body includes forming regions and material removing regions connected with the forming regions, diaphragm bodies are formed in the forming regions, and at least one corrugated structure is formed in the material removing regions. The present disclosure may effectively improve a contraction effect of a material of diaphragm disposed in the material removing regions, thereby improving an overall contraction effect of the material of the diaphragm, reducing an amount of the compensation of the diaphragm forming mold for a size of the diaphragm, so that a flatness of the diaphragm after being molded is better.

### TECHNICAL FIELD

The present disclosure relates to the field of acoustic electric conversion, in particular to a diaphragm forming mold.

### BACKGROUND

A diaphragm is mainly applied to a sound production device of an electronic device, which is a core component for constituting the sound production device, and a design of the diaphragm whether good or not directly affects acoustic performance of the sound production device, thereby affecting acoustic performance of the electronic device.

In the related art, a diaphragm forming mold for diaphragm forming generally includes a mold body having a forming region and a material removing region connected to the forming region, two opposite diaphragm bodies are formed in the forming region of the mold body, two opposite connecting portions connected to the two diaphragm bodies are formed on the material removal region of the mold body, the diaphragm bodies and the connecting portions are both convex. During a forming process of the diaphragm, due to a contraction effect of a material of the diaphragm, an actual size of the diaphragm is greatly reduced compared to a design size, at this time, in order to meet an accuracy requirement between the actual size and the design size of the diaphragm, a tool size of the diaphragm forming mold needs to be scaled up compared to the design size of the diaphragm, which may lead to a large amount of compensation of the diaphragm forming mold for a size of the diaphragm, and even needs to be compensated several times to meet the accuracy requirement between the actual size and the design size of the diaphragm, importantly, contractions of the material of the diaphragm cannot be released, and may result in a poor flatness of a formed diaphragm.

Therefore, it is necessary to improve a structure of the diaphragm forming mold described above.

### SUMMARY

A purpose of the present disclosure is to provide a diaphragm forming mold, which solves problems in the related art that a large amount of compensation of a diaphragm forming mold for a size of a diaphragm, and a poor flatness of a formed diaphragm.

The technical solution of the present disclosure is as follows:

Embodiments of the present disclosure provide a diaphragm forming mold, including a mold body, wherein the mold body includes forming regions, and material removing regions connected to the forming regions, wherein diaphragm bodies are formed in the forming regions, at least one corrugated structure is formed in the material removing regions.

As an improvement, the forming regions include a first forming region and a second forming region, the first forming region and the second forming region are oppositely arranged, the diaphragm bodies includes a first diaphragm body and a second diaphragm body, the first diaphragm body and the second diaphragm body are respectively formed in the first forming region and the second forming region, the material removing regions include a first material removing region disposed between the first forming region and the second forming region, a second material removing region disposed at the first forming region away from the first material removing region, and a third material removing region disposed at the second forming region away from the first material removing region, the at least one corrugated structure is formed in all the first material removing region, the second material removing region, and the third material removal region.

As an improvement, the mold body further includes a first side forming the diaphragm bodies and a second side opposite to the first side, the corrugated structure includes at least one groove body recessed from the first side of the mold body to the second side of the mold body.

As an improvement, the corrugated structure includes at least one groove body recessed from the second side of the mold body to the first side of the mold body.

As an improvement, the corrugated structure includes at least one protrusion portion extending from the first side of the mold body and being away from the mold body.

As an improvement, the corrugated structure includes at least one protrusion portion extending from the second side of the mold body and being away from the mold body.

As an improvement, when the corrugated structure is the groove body, a plurality of the groove bodies are provided, and each two adjacent groove bodies are spaced apart.

When the corrugated structure is the protrusion portion, a plurality of protrusion portions are provided, and each two adjacent protrusion portions are spaced apart.

As an improvement, the mold body includes a first direction from the first diaphragm body to the second diaphragm body, when the corrugated structure is the groove body, the plurality of the groove bodies are distributed at intervals along the first direction.

As an improvement, when the corrugated structure is the protrusion portion, the plurality of the protrusion portions are distributed at intervals along the first direction.

As an improvement, a first opening and a second opening are formed between ends of the first diaphragm body and the second diaphragm body, the mold body further includes a second direction from the first opening to the second opening, when the corrugated structure is the groove body, the plurality of the groove bodies extend along the second direction.

As an improvement, when the corrugated structure is the protrusion portion, the plurality of the protrusion portions extend along the second direction.

As an improvement, a shape of orthographic projection, from one end of the protrusion portion along the second direction to another end, is at least one kind of a circle, an ellipse, a triangle, a square, a rectangle, and a trapezoid.

Regarding the second direction as an observation direction, a shape of an end portion of the groove body is at least one kind of a circle, an ellipse, a triangle, a square, a rectangle, and a trapezoid.

As an improvement, each of the diaphragm bodies includes a bending portion recessed from the second side of the mold body to the first side.

As an improvement, each of the diaphragm bodies includes a bending portion recessed from the first side of the mold body to the second side.

From the above description, compared with the related art, the present disclosure has following beneficial effects:

The diaphragm bodies are formed in the forming regions of the mold body, and are configured for subsequent forming of the diaphragm, the at least one corrugated structure is formed in the material removal regions of the mold body. In a forming process of the diaphragm, the at least one corrugated structure formed in the material removing regions of the mold body may effectively improve an contraction effect of a material of the diaphragm disposed in the material removing regions, thereby improving an overall contraction effect of the material of the diaphragm, reducing an amount of the compensation of the diaphragm forming mold for the size of the diaphragm, so that the flatness of the diaphragm after being molded is better.

### BRIEF DESCRIPTION OF DRAWINGS

In order to more clearly illustrate technical solutions in embodiments of the present disclosure, drawings that need to be used in description of the embodiments or the related art are briefly introduced below, obviously, the drawings in following description are merely some embodiments of the present disclosure, for those of ordinary skill in the art, other drawings may be obtained according to these drawings without creative efforts.

FIG. 1 is a schematic diagram of a structural of a diaphragm forming mold of the related art.

FIG. 2 is a schematic diagram of a structure of a mold body provided by one embodiment of the present disclosure.

FIG. 3 is a schematic diagram of a structure of a diaphragm forming mold provided by one embodiment of the present disclosure.

FIG. 4 is a schematic diagram of a structure of a diaphragm forming mold according to one embodiment of the present disclosure.

FIG. 5 is a schematic diagram of a structure of a diaphragm forming mold according to one embodiment of the present disclosure.

FIG. 6 is a schematic diagram of a structure of a diaphragm forming mold according to one embodiment of the present disclosure.

FIG. 7 is a schematic diagram of a structure of a diaphragm forming mold provided by one embodiment of the present disclosure.

FIG. 8 is a schematic diagram of a structure of a diaphragm forming mold provided by one embodiment of the present disclosure.

FIG. 9 is a schematic diagram of a structure of a diaphragm forming mold provided by one embodiment of the present disclosure.

FIG. 10 is a schematic diagram of a structure of a diaphragm forming mold provided by one embodiment of the present disclosure.

FIG. 11 is a schematic diagram of a structure of a diaphragm forming mold provided by one embodiment of the present disclosure.

FIG. 12 is a schematic diagram of a structure of a diaphragm forming mold provided by one embodiment of the present disclosure.

FIG. 13 is a schematic diagram of a structure of a diaphragm forming mold provided by one embodiment of the present disclosure.

FIG. 14 is a schematic diagram of a structure of a diaphragm forming mold provided by one embodiment of the present disclosure.

### DETAILED DESCRIPTION OF EMBODIMENTS

In order to make objectives, technical solutions, and advantages of the present disclosure clearer, the present disclosure is further described in detail below with reference to accompanying drawings and embodiments. Wherein same or similar reference numbers from beginning to end indicate same or similar elements or elements with same or similar functions. It's understandable that specific embodiments described are merely used to explain the present disclosure, and are not intended to limit the present disclosure. In addition, technical features involved in various embodiments of the present disclosure described below may be combined with each other as long as no conflict exists between each other.

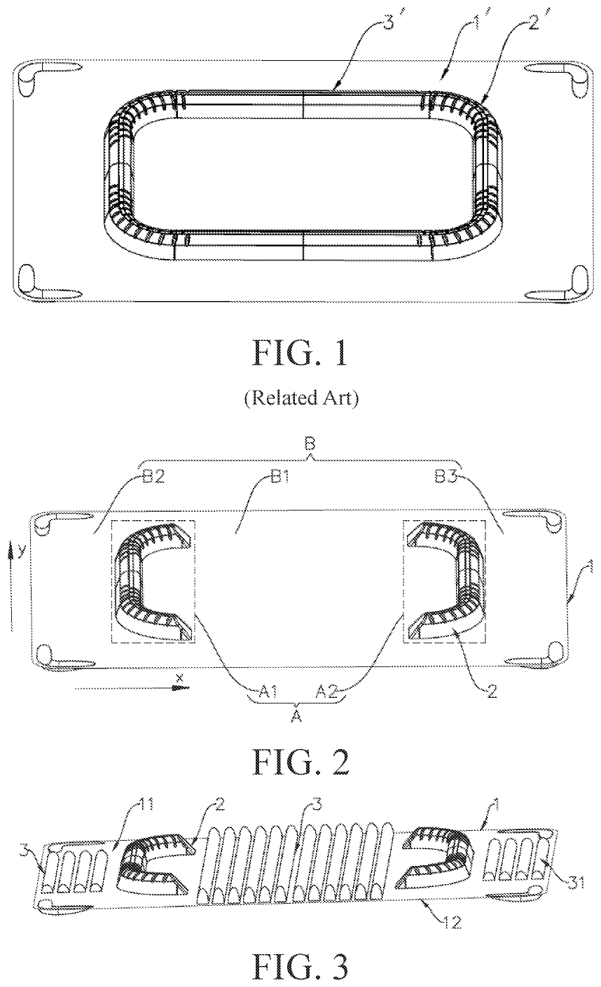

Before describing embodiments of the present disclosure, it is necessary to understand a conventional diaphragm forming mold, as shown in FIG. 1, which is a schematic diagram of a structural of a diaphragm forming mold of the related art. It can be seen from the FIG. 1, the conventional diaphragm forming mold includes a mold body 1′, two diaphragm bodies 2′ disposed opposite to each other on the mold body 1′, and two connecting portions 3′ connected to the two diaphragm bodies 2′ and disposed opposite to each other, wherein both the diaphragm bodies 2′ and the connecting portions 3′ are convex.

Embodiments of the present disclosure are described in detail below with reference to the conventional diaphragm forming mold.

Please refer to FIG. 2 and FIG. 3, FIG. 2 is a schematic diagram of a structural of a mold body according to one embodiment of the present disclosure, and FIG. 3 is a schematic diagram of a structural of a diaphragm forming mold according to one embodiment of the present disclosure.

As shown in FIG. 2 and FIG. 3, one embodiment of the present disclosure provides a diaphragm forming mold, including a mold body 1, wherein the mold body 1 includes forming regions A and material removing regions B connected to the forming regions A, diaphragm bodies 2 are formed in the forming regions A, and at least one corrugated structure 3 is formed in the material removal regions B.

Specifically, the forming regions A include a first forming region A1 and a second forming region A2, the first forming region A1 and the second forming region A2 are oppositely arranged, the diaphragm bodies 2 includes a first diaphragm body and a second diaphragm body, the first diaphragm body and the second diaphragm body are respectively formed in the first forming region A1 and the second forming region A2, the material removing regions B include a first material removing region B1 disposed between the first forming region A1 and the second forming region A2, a second material removing region B2 disposed on a side of the first forming region A1 away from the first material removing region B1, and a third material removing region B3 disposed at a side of the second forming region A2 away from the first material removing region B1.

Based on this, the at least one corrugated structure 3 may be formed in any one of the first material removal region B1, the second material removal region B2, and the third material removal region B3, and the at least one corrugated structure 3 may also be formed in any two of the first material removal region B1, the second material removal region B2, and the third material removal region B3, and the at least one corrugated structure 3 may also be formed on all the first material removal region B1, the second material removal region B2, and the third material removal region B3. When the at least one corrugated structure 3 is formed in the second material removing region B2 or the third removing region B3, the contraction effect on the first diaphragm body and the second diaphragm body may be reduced when the material of the diaphragm disposed in the second material removing region B2 or the third material removing region B3 contractions, when the at least one corrugated structure 3 is formed in the first material removal region B1, the contraction effect on the first diaphragm body and the second diaphragm body may be reduced when the material of the diaphragm disposed in the first material removing region B1 contractions. It's understandable that the at least one corrugated structure 3 is specifically formed in which regions of the first material removing region B1, the second material removing region B2, and the third material removing region B3, which are determined according to actual application scenarios, which is not limited in embodiments of the present disclosure.

In the diaphragm forming mold provided by one embodiment of the present disclosure, the diaphragm bodies 2 are formed in the forming regions A of the mold body 1, which are configured for subsequent forming of the diaphragm, the at least one corrugated structure 3 is formed in the material removal regions B of the mold body 1. In a forming process of the diaphragm, the at least one corrugated structure 3 formed in the material removing regions B of the mold body 1 may effectively improve the contraction effect of the material of the diaphragm disposed in the material removing regions B, thereby improving the overall contraction effect of the material of the diaphragm, reducing the amount of the compensation of the diaphragm forming mold for the size of the diaphragm, so that the flatness of the diaphragm after being molded is better.

In addition, it can be seen from FIG. 1 and FIG. 2, compared with the conventional diaphragm forming mold, the diaphragm forming mold provided by embodiments of the present disclosure is equivalent to removing two connecting portions 3′ that are not used for the two diaphragm bodies 2, eliminating an original contraction effect of the two connecting portions 3′, and further improving the overall contraction effect of the material of the diaphragm.

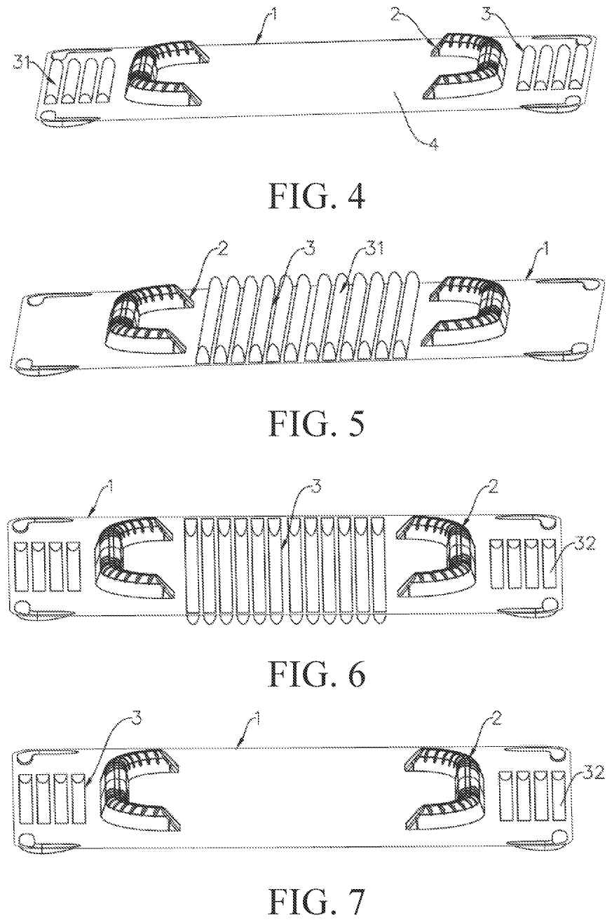

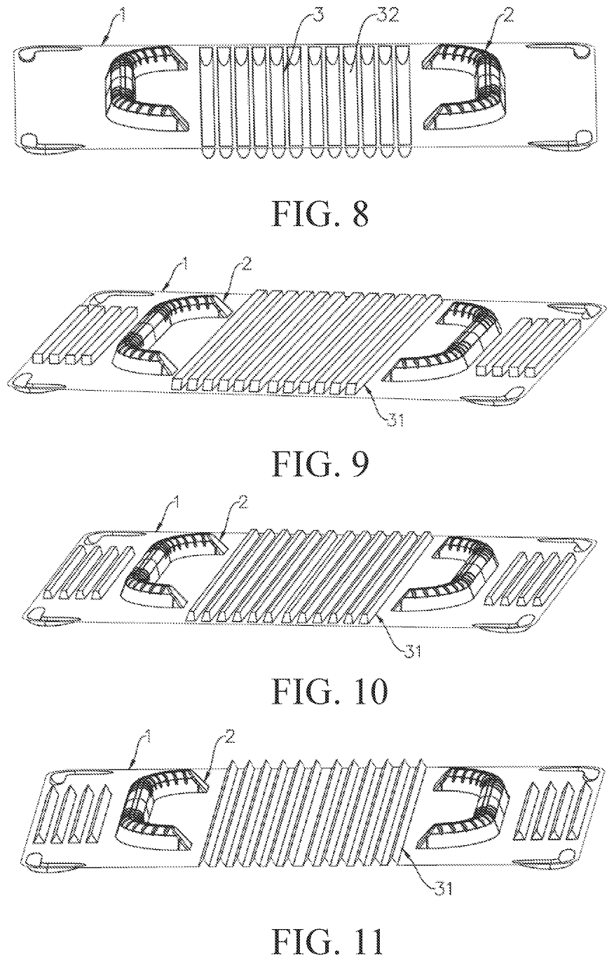

Please refer to FIGS. 4-8, FIG. 4 is a schematic diagram of a structural of a diaphragm forming mold according to one embodiment of the present disclosure, FIG. 5 is a schematic diagram of a structural of a diaphragm forming mold according to one embodiment of the present disclosure, FIG. 6 is a schematic diagram of a structural of a diaphragm forming mold according to one embodiment of the present disclosure, FIG. 7 is a schematic diagram of a structural of a diaphragm forming mold according to one embodiment of the present disclosure, FIG. 8 is a schematic diagram of a structural of a diaphragm forming mold according to one embodiment of the present disclosure.

As an improvement, a first opening and a second opening are oppositely formed between ends of the first diaphragm body and the second diaphragm body, and the mold body 1 includes a first side 11 forming the diaphragm bodies 2, a second side 12 opposite to the first side 11, a first direction x pointing from the first diaphragm body to the second diaphragm body, and a second direction y pointing from the first opening to the second opening.

Further, as shown in FIG. 4 and FIG. 5, the corrugated structure 3 includes at least one protrusion portion 31 extending from the first side 11 of the mold body 1 and being away from the mold body 1. Certainly, a structural form of the protrusion portion 31 is not limited this, and in other structural forms, the protrusion portion 31 may be formed by extending from the second side 12 of the mold body 1 and being away from the mold body 1. It's understandable that a specific structural form of the protrusion portion 31 is determined according to actual application scenarios, which is not limited in embodiments of the present disclosure.

In other embodiments, as shown in FIGS. 6-8, the protrusion portion 31 may be replaced by a recessed groove body, that is, the corrugated structure 3 may include a groove body 32 recessed from the first side 11 of the mold body 1 to the second side 12 of the mold body 1. Certainly, a structure form of the groove body 32 is not limited this, and in other structural forms, the groove body 32 may be recessed from the second side 12 of the mold body 1 to the first side 11 of the mold body 1. It's understandable that a specific structural form of the groove body 32 is determined according to actual application scenarios, which is not limited in embodiments of the present disclosure.

Further, when the corrugated structure 3 is the groove body 32, a plurality of the groove bodies 32 are provided, and each two adjacent groove bodies 32 are spaced apart, specifically, and the plurality of groove bodies 32 are distributed at intervals along the first direction x, and all extend along the second direction y. When the corrugated structure 3 is the protrusion portion 31, a plurality of protrusion portions 31 are provided, each two adjacent groove bodies 31 are spaced apart, specifically, the plurality of protrusion portions 31 are distributed at intervals along the first direction x, and all extend along the second direction y.

In addition, each of the diaphragm bodies 2 may include a bending portion formed by recessing from the second side 12 of the mold body 1 to the first side 11. Certainly, a structure form of the diaphragm bodies 2 is not limited this, and in other structural forms, each of the diaphragm bodies 2 may include a diaphragm body bending portion recessed from the first side 11 of the mold body 1 to the second side 12 of the mold body 1. It's understandable that a specific structure form of the diaphragm bodies 2 is determined according to actual application scenarios, which is not limited in embodiments of the present disclosure.

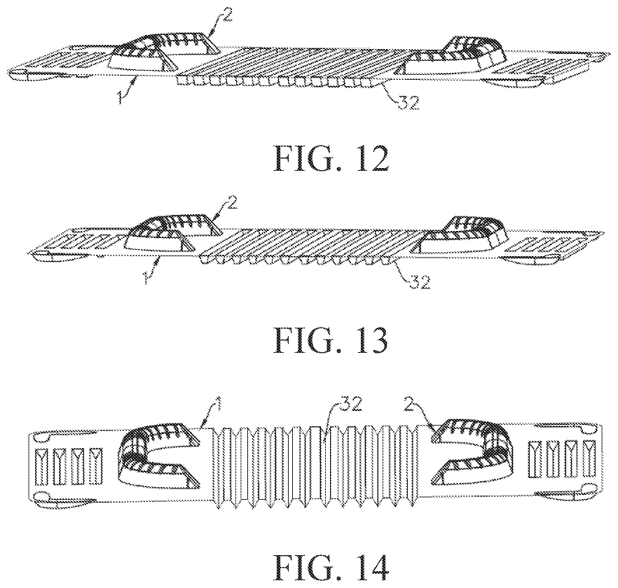

Please further refer to FIGS. 9-14, FIG. 9 is a schematic diagram of a structural of a diaphragm forming mold provided by one embodiment of the present disclosure, FIG. 9 is a schematic diagram of a structural of a diaphragm forming mold provided by one embodiment of the present disclosure, FIG. 10 is a schematic diagram of a structural of a diaphragm forming mold provided by one embodiment of the present disclosure, FIG. 11 is a schematic diagram of a structural of a diaphragm forming mold provided by one embodiment of the present disclosure, FIG. 12 is a schematic diagram of a structural of a diaphragm forming mold provided by one embodiment of the present disclosure, FIG. 13 is a schematic diagram of a structural of a diaphragm forming mold provided by one embodiment of the present disclosure, FIG. 14 is a schematic diagram of a structural of a diaphragm forming mold provided by one embodiment of the present disclosure.

FIGS. 9-14 mainly illustrate some shapes of orthographic projection, form one end of the protrusion portion 31 along the second direction y to another end, and some shapes of an end portion of the groove body 32, the following are examples.

As an example, as shown in FIGS. 9-11, a shape of the orthographic projection, from one end of the protrusion portion 31 along the second direction y to another end, may be any one kind of a triangle, a square, a rectangle, and a trapezoid. Certainly, the shape of the orthographic projection, from one end of the protrusion portion 31 along the second direction y to another end, may also be a circle or an oval shape as shown in FIG. 3. It's understandable that the shape of the orthographic projection, from one end of each of the protrusion portions 31 in the at least one corrugated structure 3 along the second direction y to another end may be one of above-mentioned shapes, or a combination of some of the above-mentioned shapes, which is not limited in embodiments of the present disclosure.

As an example, as shown in FIGS. 12-14, taking the second direction y as an observation direction, a shape of the end portion of the groove body 32 may be any one kind of a triangle, a square, a rectangle, and a trapezoid. Certainly, the shape of the end portion of the groove body 32 may also be a circle or an ellipse as shown in FIG. 6. It's understandable that the shape of the end portion of each of the groove bodies 32 in the at least one corrugated structure 3, taking the second direction y as the observation direction, may be one of above-mentioned shapes, or a combination of some of the above-mentioned shapes, which is not limited in embodiments of the present disclosure.

It should be noted that each of the embodiments of the present disclosure is described in a progressive manner, and each of the embodiments focuses on a difference from other embodiments, and same or similar parts between the embodiments can be seen with reference to each other.

It should also be noted that, in the present disclosure, relational terms such as first and second are merely used to distinguish one entity or operation from another entity or operation without necessarily requiring or implying any such actual relationship or order between these entities or operations. Moreover, the terms “include”, “comprise”, or any other variations are intended to cover a non-exclusive inclusion, so that a process, method, article or equipment that includes a series of elements includes not only those elements, but also other elements that are not explicitly listed, or also includes inherent elements of the process, method, article or equipment, when there are no more restrictions, elements defined by a sentence “including a” does not exclude existence of other identical elements in the process, method, article, or equipment that includes the element.

The above description of disclosed embodiments enables those skilled in the art to make or use the present disclosure. Various modifications to these embodiments are apparent to those skilled in the art, general principles defined in the present disclosure may be implemented in other embodiments without departing from the spirit or scope of the present disclosure. Therefore, the present disclosure is not limited to these embodiments shown in the present disclosure, but is to be accorded the widest scope consistent with principles and novel features disclosed in the present disclosure.

What is claimed is:

1. A diaphragm forming mold, comprising a mold body, comprising:
forming regions; and
material removing regions connected to the forming regions;
wherein diaphragm bodies are formed in the forming regions, at least one corrugated structure is formed in the material removing regions.

2. The diaphragm forming mold according to claim 1, wherein the forming regions comprise a first forming region and a second forming region, the first forming region and the second forming region are oppositely arranged; the diaphragm bodies comprises a first diaphragm body and a second diaphragm body, the first diaphragm body and the second diaphragm body are respectively formed in the first forming region and the second forming region; the material removing regions comprise a first material removing region disposed between the first forming region and the second forming region, a second material removing region disposed at the first forming region away from the first material removing region, and a third material removing region disposed at the second forming region away from the first material removing region; and the at least one corrugated structure is formed in all the first material removing region, the second material removing region, and the third material removing region.

3. The diaphragm forming mold according to claim 2, wherein the mold body further comprises a first side forming the diaphragm bodies and a second side opposite to the first side, the corrugated structure comprises at least one groove body recessed from the first side of the mold body to the second side of the mold body; or
the corrugated structure comprises at least one groove body recessed from the second side of the mold body to the first side of the mold body; or
the corrugated structure comprises at least one protrusion portion extending from the first side of the mold body and being away from the mold body; or
the corrugated structure comprises at least one protrusion portion extending from the second side of the mold body and being away from the mold body.

4. The diaphragm forming mold according to claim 3, wherein when the corrugated structure is the groove body, a plurality of the groove bodies are provided, and each two adjacent groove bodies are spaced apart;
when the corrugated structure is the protrusion portion, a plurality of the protrusion portions are provided, and each two adjacent protrusion portions are spaced apart.

5. The diaphragm forming mold according to claim 4, wherein the mold body comprises a first direction from the first diaphragm body to the second diaphragm body, when the corrugated structure is the groove body, the plurality of the groove bodies are distributed at intervals along the first direction;
when the corrugated structure is the protrusion portion, the plurality of the protrusion portions are distributed at intervals along the first direction.

6. The diaphragm forming mold according to claim 5, wherein a first opening and a second opening are oppositely formed between ends of the first diaphragm body and the second diaphragm body, the mold body further comprises a second direction from the first opening to the second opening, when the corrugated structure is the groove body, the plurality of the groove bodies extend along the second direction;
when the corrugated structure is the protrusion portion, the plurality of the protrusion portions extend along the second direction.

7. The diaphragm forming mold according to claim 6, wherein a shape of orthographic projection, from one end of the protrusion portion along the second direction to another end, is at least one kind of a circle, an ellipse, a triangle, a square, a rectangle, and a trapezoid;
taking the second direction as an observation direction, a shape of an end portion of the groove body is at least one kind of a circle, an ellipse, a triangle, a square, a rectangle, and a trapezoid.

8. The diaphragm forming mold according to claim 3, wherein each of the diaphragm bodies comprises a bending portion recessed from the second side of the mold body to the first side of the mold body; or
each of the diaphragm bodies comprises a bending portion recessed from the first side of the mold body to the second side of the mold body.
